(19) United States
(12) Patent Application Publication
(10) Pub. No.: US 2023/0044953 A1
(43) Pub. Date: Feb. 9, 2023

(54) INFORMATION PROCESSING DEVICE, PROGRAM, SYSTEM, AND INFORMATION PROCESSING METHOD

(71) Applicant: HONDA MOTOR CO.,LTD., Tokyo (JP)

(72) Inventors: Masaru OTAKA, Tokyo (JP); Ryusuke TAMANAHA, Tokyo (JP); Shohei TSUKAHARA, Tokyo (JP); Ryo SAIKI, Tokyo (JP); Yusuke OI, Tokyo (JP); Takahiro IIJIMA, Tokyo (JP); Naoko IMAI, Tokyo (JP)

(21) Appl. No.: 17/970,494

(22) Filed: Oct. 20, 2022

Related U.S. Application Data
(63) Continuation of application No. PCT/JP2020/019067, filed on May 13, 2020.

(51) Int. Cl. B60W 50/00; G07C 5/00

(52) U.S. Cl. CPC B60W 50/0098; G07C 5/008; B60W 2050/0064; B60W 2420/42

(57) ABSTRACT

Provided is an information processing device including: a first acquisition unit configured to acquire a task; a second acquisition unit configured to acquire a processing time of the task; a third acquisition unit configured to acquire a wirelessly communicable period with an external communication device; and a communication control unit configured to control, based on the processing time and the wirelessly communicable period, a wireless communication unit to transmit request information to the external communication device, the request information requesting to process at least a part of the task, in which the communication control unit is configured to control the wireless communication unit to perform direct communication with the external communication device.

The contents of the following Japanese patent application(s) are incorporated herein by reference:

NO. PCT/JP2020/019067 filed in WO on May 13, 2020

### BACKGROUND

### 1. Technical Field

The present invention relates to an information processing device, a program, a system, and an information processing method.

### 2. Related Art

Patent Document 1 describes a vehicle distribution processing system constituted of a plurality of vehicle devices mounted on a plurality of vehicles and a center device connected to the vehicle devices via a network. Patent Document 2 discloses an invention of calculating how long a traveling vehicle can communicate with an access point on a traveling path.

### Prior Art Documents

### Patent Documents

Patent Document 1: Japanese Patent Application Publication No. 2013-120526

Patent Document 2: U.S. Patent Application Publication No. 2016/0150451

### BRIEF DESCRIPTION OF THE DRAWINGS

FIG. 1 schematically shows an example of a system 10.

FIG. 2 schematically shows an example of a functional configuration of an information processing device 200.

FIG. 3 schematically shows an example of a processing flow of the information processing device 200.

FIG. 4 is an explanatory diagram for describing a distribution of processing.

FIG. 5 is an explanatory diagram for describing a division of a task by a vehicle 100 and other vehicles 100.

FIG. 6 schematically shows an example of a functional configuration of a fixed AP 400 that functions as an information processing device.

FIG. 7 schematically shows an example of a hardware configuration of a computer 1200 that functions as the information processing device 200 or the fixed AP 400.

### DESCRIPTION OF EXEMPLARY EMBODIMENTS

Hereinafter, the present invention will be described through embodiments of the invention, but the following embodiments do not limit the claimed invention. In addition, not all combinations of features described in the embodiments necessarily have to be essential to solving means of the invention.

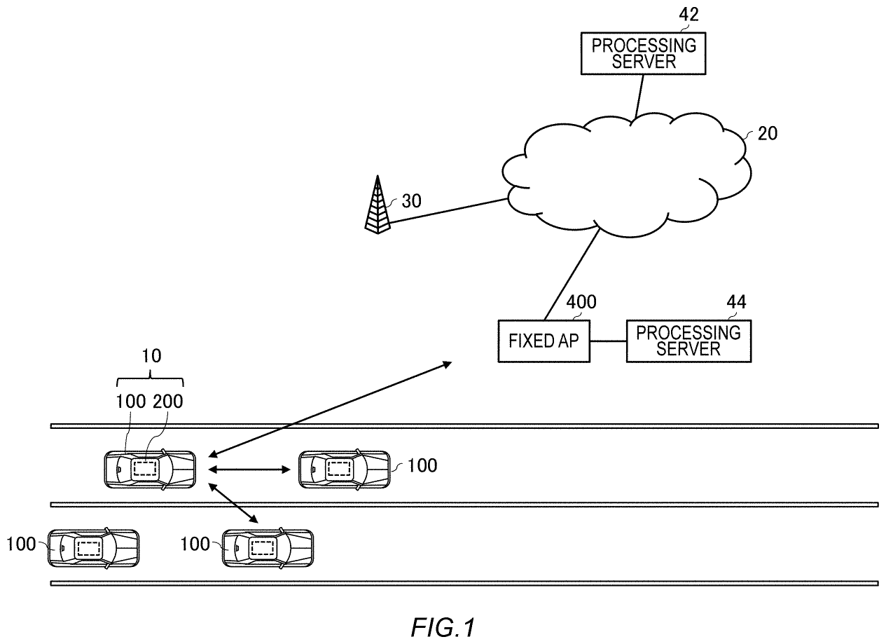

FIG. 1 schematically shows an example of a system 10. The system 10 includes vehicles 100 and an information processing device 200. In an example shown in FIG. 1, the information processing device 200 is mounted on the vehicle 100. The vehicle 100 may be an example of a movable object.

The vehicle 100 may be an automobile. The vehicle 100 may be any type of automobile, or may be a motorbike. The vehicle 100 may be a gasoline vehicle or may be a so-called eco-car. Examples of a type of the eco-car include an HV (Hybrid Vehicle), a PHEV/PHV (Plug-in Hybrid Vehicle), an EV (Electric Vehicle), an FCV (Fuel Cell Vehicle), and the like. The vehicle 100 is, for example, a private vehicle. Note that the vehicle 100 may be an automobile for any purpose. For example, the vehicle 100 may be a business vehicle such as a taxi, a bus, and a mobile sales vehicle.

The information processing device 200 according to the present embodiment distributes processing of a task to an external communication device. The external communication device may be movable. For example, the external communication device is another vehicle 100. The external communication device may be mounted on a movable object. For example, the external communication device is an information processing device 200 mounted on the another vehicle 100. The external communication device may be installed fixedly. In FIG. 1, a fixed AP 400 is exemplified as the external communication device that is installed fixedly.

Using cellular communication via a wireless base station 30, the information processing device 200 can request the external communication device to process at least a part of a task. The wireless base station 30 may be compliant with any cellular communication system. The wireless base station 30 is compliant with, for example, 4G (4th Generation) of an LTE (Long Term Evolution) communication system or an LTE-Advanced communication system. The wireless base station 30 is compliant with, for example, a 3G (3rd Generation) communication system. The wireless base station 30 is compliant with, for example, a 5G (5th Generation) communication system. The wireless base station 30 is compliant with, for example, a cellular communication system that is a 6G (6th Generation) communication system and beyond.

By using cellular communication, the information processing device 200 can distribute, via the wireless base station 30 providing a service area in which the information processing device 200 is located, processing of a task to external communication devices located within service areas of wireless base stations 30 at various locations. Further, the information processing device 200 can distribute, via the wireless base station 30 and a network 20 including a mobile communication network and the Internet, processing of a task to a processing server 42 on the Internet.

However, in general, a pay-as-you-go billing system or a packet flat-rate system is adopted in the cellular communication, and thus a communication cost is generated. Alternatively, the communication cost is higher than those of other communication systems to be described later. When distributing the processing of a task, it is desirable to lower the communication cost.

The information processing device 200 according to the present embodiment uses a communication system having a lower communication cost than the cellular communication system to communicate with the external communication device and distribute the processing of a task. For example, the information processing device 200 performs direct wireless communication with the external communication device to perform control so as to transmit request information that requests to process at least a part of a task to the external communication device or receive a processing result from the external communication device.

For example, the information processing device 200 controls a wireless communication unit of the vehicle 100 so as to perform direct communication with the external communication device. When the information processing device 200 itself includes a wireless communication unit, the information processing device 200 may control its own wireless communication unit so as to perform direct communication with the external communication device.

For example, using vehicle-to-vehicle communication between the vehicle 100 and another vehicle 100, the information processing device 200 performs control so as to transmit request information to the another vehicle 100 or receive a processing result from the another vehicle 100. The vehicle-to-vehicle communication may be narrowband wireless communication. Examples of the narrowband wireless communication include Wi-Fi (registered trademark) (Wireless Fidelity), DSRC (Dedicated Short Range Communications), C-V2X, PC5, Bluetooth (registered trademark), and the like. In general, a pay-as-you-go billing system or the like is not adopted in the vehicle-to-vehicle communication, and thus the communication cost does not increase even when a communication volume increases. Therefore, by using the vehicle-to-vehicle communication, the communication cost can be lowered as compared to the case of using cellular communication.

Further, for example, by the direct communication with the fixed AP 400, the information processing device 200 performs control so as to transmit request information to the fixed AP 400 or receive a processing result from the fixed AP 400. The fixed AP 400 may be, for example, a so-called RSU (Road Side Unit). The information processing device 200 may communicate with the fixed AP 400 by narrowband wireless communication. The fixed AP 400 may be a so-called Wi-Fi hotspot. For example, the fixed AP 400 is a free Wi-Fi hotspot provided by a roadside convenience store or the like. By using the free Wi-Fi hotspot, a distribution of processing of a task can be achievable without generating a communication cost.

When receiving request information, the fixed AP 400 itself may process a task and transmit a processing result to the information processing device 200. Further, the fixed AP 400 may cause the processing server 42 to process a task via the network 20 and transmit a processing result to the information processing device 200. Furthermore, the fixed AP 400 may cause a processing server 44 connected by a dedicated line to process a task and transmit a processing result to the information processing device 200. The processing server 44 may be a so-called MEC (Mobile Edge Computing) server, or a relay communication device may be provided between the fixed AP 400 and the processing server 42.

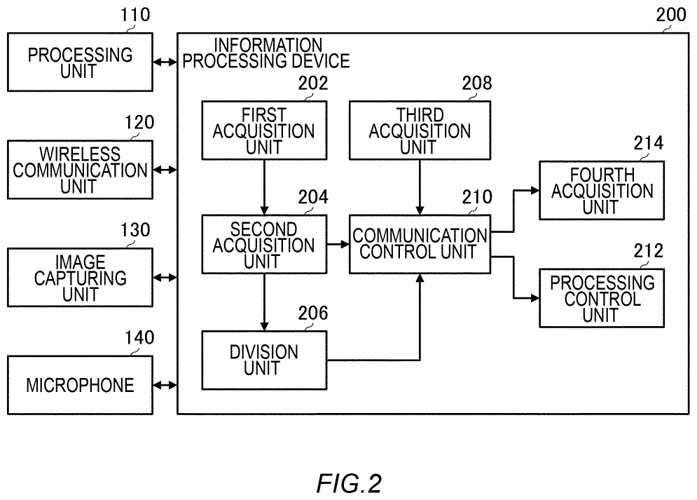

FIG. 2 schematically shows an example of a functional configuration of the information processing device 200. The information processing device 200 includes a first acquisition unit 202, a second acquisition unit 204, a division unit 206, a third acquisition unit 208, a communication control unit 210, a processing control unit 212, and a fourth acquisition unit 214. Note that the information processing device 200 does not necessarily include all of these components.

The first acquisition unit 202 acquires a task as a processing target. The first acquisition unit 202 generates a task as a processing target, for example. The first acquisition unit 202 may acquire or generate (hereinafter, will be expressed as acquire) a task related to a movable object on which the information processing device 200 is mounted. For example, the first acquisition unit 202 acquires a task related to the vehicle 100 on which the information processing device 200 is mounted. The first acquisition unit 202 acquires a task of a deep learning analysis in the vehicle 100, for example.

Further, for example, the first acquisition unit 202 acquires a task of analyzing a captured image captured by an image capturing unit 130 mounted on the vehicle 100. Examples of such a task include a task of analyzing a captured image captured by the image capturing unit 130 that captures inside of a vehicle to determine an in-vehicle state, and a task of analyzing a captured image captured by the image capturing unit 130 that captures outside of a vehicle to determine an outside situation of the vehicle 100. By the former task, a correlation between a position, traffic condition, weather, or the like of where the vehicle 100 is traveling and the in-vehicle state can be analyzed. By the latter task, a situation of each location, a gasoline price at a gas station at each location, and the like can be analyzed.

Further, for example, the first acquisition unit 202 acquires a task of analyzing a voice acquired by a microphone 140 mounted on the vehicle 100. Examples of such a task include a task of analyzing a voice acquired by the microphone 140 arranged inside the vehicle to determine an in-vehicle state and a task of analyzing a voice acquired by the microphone 140 arranged outside the vehicle to determine an outside situation of the vehicle 100.

In addition to the examples described above, the first acquisition unit 202 may acquire or generate any type of task related to the vehicle 100. Alternatively, the first acquisition unit 202 may acquire or generate any type of task unrelated to the vehicle 100.

The first acquisition unit 202 may also acquire a task included in request information received from the external communication device. For example, the first acquisition unit 202 acquires a task included in request information received from another vehicle 100 via a wireless communication unit 120. For example, the first acquisition unit 202 acquires a task included in request information received from the fixed AP 400 via the wireless communication unit 120. The first acquisition unit 202 may also receive a task from any device on the network 20.

The second acquisition unit 204 acquires a processing time of the task acquired by the first acquisition unit 202. The second acquisition unit 204 predicts a processing time of the task according to a content of the task, for example. As a specific example, the second acquisition unit 204 predicts the processing time of the task based on at least one of a task data amount or a task type. The second acquisition unit 204 may derive, as a prediction result, the processing time which becomes longer as the task data amount increases. The second acquisition unit 204 may derive a processing time corresponding to the task type as the prediction result. The second acquisition unit 204 may store in advance registration data in which a relationship between the task type and the processing time are registered, and reference the registration data to determine the processing time corresponding to the task type.

The second acquisition unit 204 may derive an expected processing time in a case where a processing unit 110 capable of executing various types of processing processes a task, as a prediction result of the processing time of the task. The processing unit 110 may be an example of a task processing unit. For example, the second acquisition unit 204 can derive, based on processing performance and an available resource of the processing unit 110, the expected processing time in the case where the processing unit 110 processes a task. In the present embodiment, descriptions will be given while mainly taking a case of using the processing unit 110 of the movable object on which the information processing device 200 is mounted as an example, but a processing unit provided in the information processing device 200 may be used instead.

The second acquisition unit 204 may derive, as the prediction result of the processing time of the task, an expected processing time in a case where an external communication device in the vicinity of the movable object on which the information processing device 200 is mounted processes a task. For example, the second acquisition unit 204 can acquire in advance from the external communication device the processing performance and available resource of the external communication device, and derive, based on the processing performance and available resource of the external communication device, an expected processing time in a case where the external communication device processes a task.

The division unit 206 may divide the task acquired by the first acquisition unit 202 into an own processing task to be processed by the processing unit 110 and a request task that is requested to be processed by the external communication device. The processing time acquired by the second acquisition unit 204 may include an own processing time during which the processing unit 110 processes the own processing task and an external processing time during which the external communication device processes the request task. The division unit 206 may divide the task into the own processing task and the request task based on the processing time including the own processing time and the external processing time.

The division unit 206 may divide the task acquired by the first acquisition unit 202 into an own processing task and a plurality of request tasks respectively corresponding to the plurality of external communication devices. The division unit 206 may divide the task acquired by the first acquisition unit 202 into a plurality of request tasks requested to be respectively processed by the plurality of external communication devices.

The third acquisition unit 208 acquires a wirelessly communicable period with the external communication device. The third acquisition unit 208 may acquire, as the wirelessly communicable period, a period during which the information processing device 200 is located within a wireless communication zone of the external communication device.

The third acquisition unit 208 may predict the wirelessly communicable period based on movement-related information which is related to a movement of the movable object on which the information processing device 200 is mounted. For example, when the information processing device 200 is mounted on the vehicle 100 and the external communication device is the fixed AP 400, the third acquisition unit 208 predicts the wirelessly communicable period based on location information of the fixed AP 400 and movement-related information of the vehicle 100. The movement-related information of the vehicle 100 may include one or more pieces of information out of location information, traveling direction, traveling speed, destination, road condition, traffic jam information, and traveling history of the vehicle 100. Regarding the fixed AP 400, a connection time with the fixed AP 400 or a similar fixed AP of the past, a history of radio field intensities, or statistical information may also be used.

The third acquisition unit 208 may predict the wirelessly communicable period based on first movement-related information related to a movement of the movable object on which the information processing device 200 is mounted and second movement-related information related to a movement of the movable object on which the external communication device is mounted. For example, when the information processing device 200 is mounted on the vehicle 100 and the external communication device is mounted on another vehicle 100, the third acquisition unit 208 predicts the wirelessly communicable period based on the first movement-related information of the vehicle 100 and the second movement-related information of the another vehicle 100. The first movement-related information may include one or more pieces of information out of location information, traveling direction, traveling speed, destination, road condition, traffic jam information, and traveling history of the vehicle 100. The second movement-related information may include one or more pieces of information out of location information, traveling direction, traveling speed, destination, road condition, traffic jam information, and traveling history of the another vehicle 100. The plurality of vehicles 100 may share the movement-related information by direct communication or indirect communication such as cellular communication.

The communication control unit 210 controls the wireless communication unit 120. Based on the processing time acquired by the second acquisition unit 204 and the wirelessly communicable period acquired by the third acquisition unit 208, the communication control unit 210 may control the wireless communication unit 120 to transmit, to the external communication device, request information that requests to process at least a part of the task as the processing target, that has been acquired by the first acquisition unit 202. The communication control unit 210 may control the wireless communication unit 120 to perform direct communication with the external communication device.

When the external communication device is requested to process at least a part of the task and it is determined, based on the processing time and the wirelessly communicable period, that a processing result can be received from the external communication device, the communication control unit 210 may control the wireless communication unit 120 to transmit request information to the external communication device.

When requesting one external communication device to process a whole task acquired by the first acquisition unit 202, the communication control unit 210 may transmit request information including the task to the one external communication device. When the task is divided into the own processing task and the request task by the division unit 206, the communication control unit 210 may control the processing control unit 212 to cause the processing unit 110 to process the own processing task, and control the wireless communication unit 120 to transmit request information that requests to process the request task to the external communication device.

When the task acquired by the first acquisition unit 202 is divided into the own processing task and a plurality of request tasks by the division unit 206, the communication control unit 210 may control the processing control unit 212 to cause the processing unit 110 to process the own processing task, and control the wireless communication unit 120 to respectively transmit the plurality of request tasks to the plurality of external communication devices. When the task acquired by the first acquisition unit 202 is divided into a plurality of request tasks by the division unit 206, the communication control unit 210 may control the wireless communication unit 120 to respectively transmit the plurality of request tasks to the plurality of external communication devices.

When the first acquisition unit 202 acquires a task included in the request information received from the external communication device and a predetermined condition is satisfied, the communication control unit 210 may cause the wireless communication unit 120 to transmit a rejection response that rejects execution of the task to the external communication device that has transmitted the request information. For example, the communication control unit 210 causes the wireless communication unit 120 to transmit the rejection response when a setting to reject execution of the requested task is made by a passenger of the vehicle 100 or the like. For example, the communication control unit 210 causes the wireless communication unit 120 to transmit the rejection response when a task requested by another external communication device is already being executed. For example, the communication control unit 210 causes the wireless communication unit 120 to transmit the rejection response when the processing unit 110 is executing the own processing task. For example, the communication control unit 210 causes the wireless communication unit 120 to transmit the rejection response when an available resource of the processing unit 110 is smaller than a predetermined threshold.

The fourth acquisition unit 214 acquires a response to the request information that the wireless communication unit 120 has transmitted to the external communication device. When the fourth acquisition unit 214 does not acquire the response before a predetermined time elapses since the wireless communication unit 120 has transmitted the request information to the external communication device, the communication control unit 210 may cause the wireless communication unit 120 to transmit the request information to another external communication device using direct communication or indirect communication.

An example of the indirect communication is cellular communication. The communication control unit 210 may cause the wireless communication unit 120 to transmit the request information to another external communication device via the wireless base station 30 and the network 20. Accordingly, although a communication cost is generated, it becomes possible to prevent a situation where a task request is delayed to result in a delay of processing of the task from occurring.

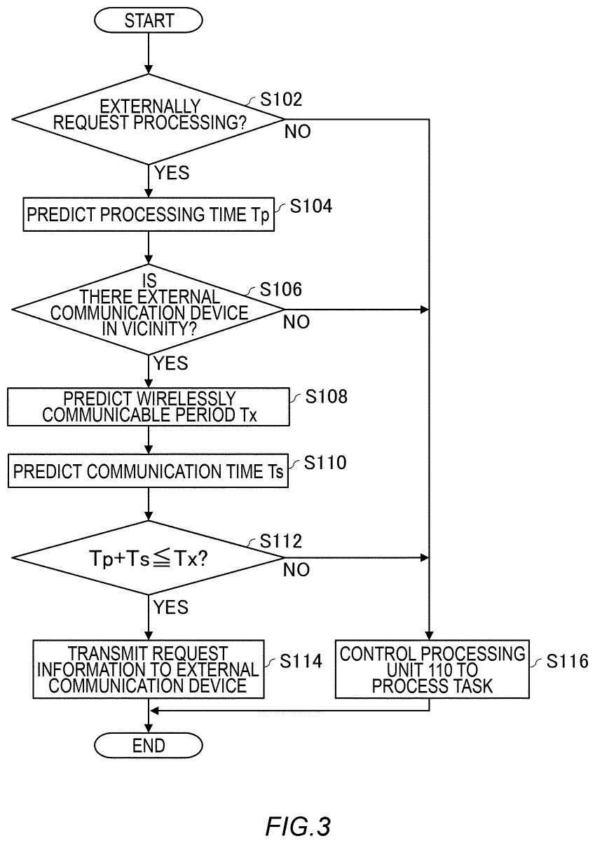

FIG. 3 schematically shows an example of a processing flow of the information processing device 200. The information processing device 200 may start processing shown in FIG. 3 upon acquiring a task by the first acquisition unit 202. Herein, a case where the acquired task is not divided will be described.

In S102, the communication control unit 210 determines whether to externally request processing of the acquired task. For example, the communication control unit 210 determines not to externally request the processing when determining that the task can be processed by the processing unit 110, and determines to externally request the processing when determining that the task cannot be processed by the processing unit 110. For example, the communication control unit 210 determines that the task cannot be processed by the processing unit 110 when a processing amount of the task is large with respect to the available resource of the processing unit 110.

The communication control unit 210 may determine to externally request the processing when a setting to prioritize a task processing speed is made, and determine not to externally request the processing when the setting is not made. The communication control unit 210 may determine whether to externally request the processing according to the task type. For example, the communication control unit 210 determines to externally request the processing in a case of a task that places importance on immediacy, and determines not to externally request the processing in a case of a task that does not place importance on immediacy. The communication control unit 210 may store in advance registration data in which whether to place importance on immediacy is registered for each task type, and reference the registration data to determine whether the acquired task is a task that places importance on immediacy.

When determined to externally request the processing, the processing advances to S104, and when determined not to request, the processing advances to S116. In S104, the second acquisition unit 204 predicts a processing time Tp of the task.

In S106, the communication control unit 210 determines whether there is an external communication device in the vicinity. The communication control unit 210 may determine that there is an external communication device in the vicinity when it is wirelessly communicable with the external communication device by the wireless communication unit 120. The communication control unit 210 may determine whether it is wirelessly communicable with the external communication device by referencing a status of radio waves received by the wireless communication unit 120.

The communication control unit 210 may determine whether there is an external communication device in the vicinity based on location information of the external communication device. For example, in an environment where the plurality of vehicles 100 share location information, the communication control unit 210 may determine whether there is an external communication device in the vicinity by referencing location information of other vehicles 100 and location information of the fixed AP 400 stored in advance. When determined that there is an external communication device in the vicinity, the processing advances to S108, and when determined that there is no external communication device, the processing advances to S116.

In S108, the third acquisition unit 208 predicts a wirelessly communicable period Tx with respect to the external communication device. In S110, the third acquisition unit 208 predicts a communication time Ts with the external communication device. The third acquisition unit 208 may predict the communication time Ts based on a task data amount and a communication status with the external communication device. The communication status may indicate a communication type, a physical distance, an interference status, and the like.

In S112, the communication control unit 210 determines whether an addition value obtained by adding the processing time Tp and the communication time Ts is equal to or smaller than a wirelessly communicable period Tx. When determined as being Tx or less, the processing advances to S114, and when determined as not being Tx or less, the processing advances to S116.

In S114, the communication control unit 210 transmits request information that requests to process a task to the external communication device. Then, the communication control unit 210 waits for a processing result of the task. Note that when the fourth acquisition unit 214 does not acquire a response before a predetermined time elapses since the request information has been transmitted in S114, the communication control unit 210 may cause the wireless communication unit 120 to transmit the request information to another external communication device using direct communication or indirect communication.

In S116, the processing control unit 212 controls the processing unit 110 to process the task. Note that in S116, the communication control unit 210 may request the external communication device to process the task by indirect communication instead of causing the processing unit 110 to process the task. Further, when determined that there is no external communication device in the vicinity in S106, the communication control unit 210 may stand by until there is an external communication device in the vicinity.

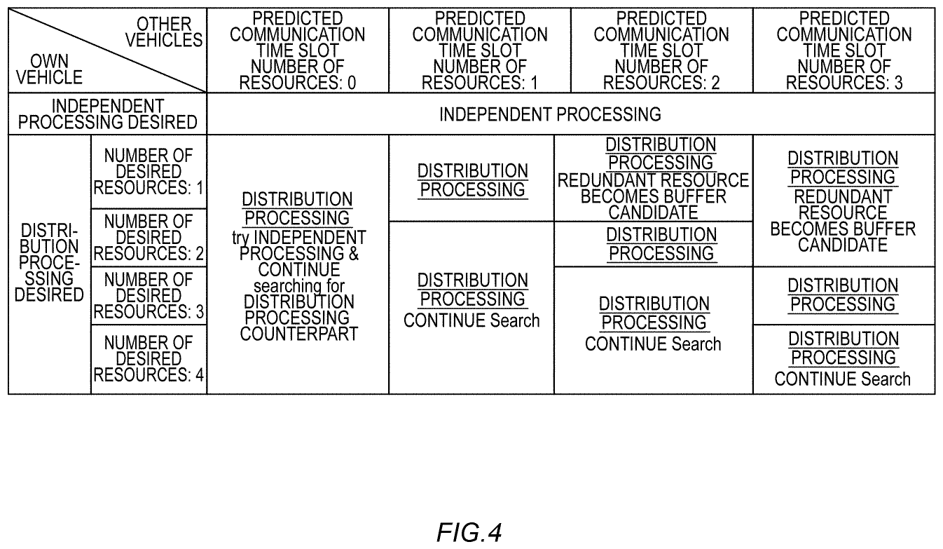

FIG. 4 is an explanatory diagram for describing a distribution of processing. Herein, descriptions will be given while taking, as an example, a case where the information processing device 200 is mounted on the vehicle 100 and there are zero to three resources in a predicted communication time slot regarding a case where the information processing device 200 wishes independent processing and a case where the information processing device 200 wishes distribution processing (number of desired resources is one to four).

When the information processing device 200 wishes independent processing, the processing is not distributed, and the processing control unit 212 causes the processing unit 110 to process the task. When the information processing device 200 wishes independent processing, a processing request from other vehicles may be rejected.

When the number of resources in a predicted communication time slot is zero, that is, there is no external communication device in the vicinity, the distribution processing cannot be carried out, so the information processing device 200 continues to search for a distribution processing counterpart as well as attempting to carry out independent processing. When the number of resources in the predicted communication time slot is one and the number of desired resources is one, the distribution processing is performed, and when the number of desired resources is two to four, the distribution processing counterpart is continued to be searched for while performing the distribution processing with respect to one resource.

When the number of resources in the predicted communication time slot is two and the number of desired resources is one, the distribution processing is performed, and another redundant vehicle resource is managed as a buffer candidate to be used at a time of distribution processing breakdown. When the number of desired resources is two, the distribution processing is performed, and when the number of desired resources is three or four, the distribution processing counterpart is continued to be searched for while performing the distribution processing with respect to the two resources.

When the number of resources in the predicted communication time slot is three and the number of desired resources is one or two, the distribution processing is performed, and other redundant vehicle resources are managed as buffer candidates to be used at a time of distribution processing breakdown. When the number of desired resources is one, the distribution processing is performed, and when the number of desired resources is four, the distribution processing counterpart is continued to be searched for while performing the distribution processing with respect to the three resources.

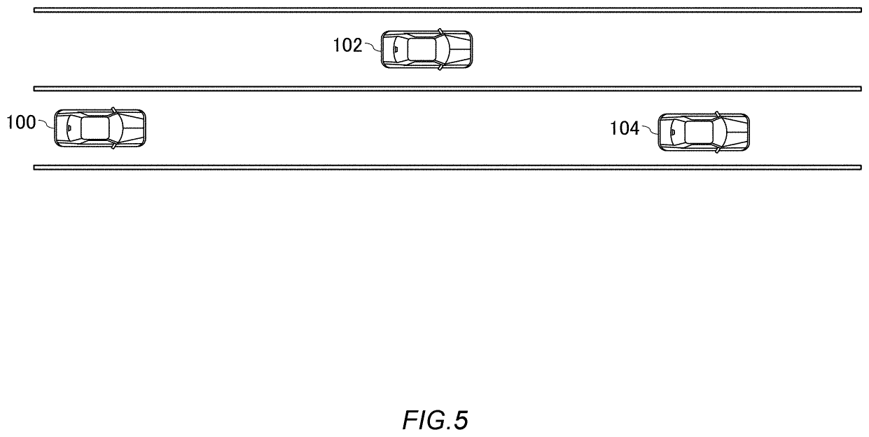

FIG. 5 is an explanatory diagram for describing the division of a task by the vehicle 100 and other vehicles 100. In FIG. 5, a vehicle 102 and a vehicle 104 are exemplified as the other vehicles 100.

The communication control unit 210 can set a task processing capacity of each vehicle based on the following Expressions 1 to 4.

c=∫_{T0}^{Te}P0(t)dt+∫_{Tc1}^{Te}P1(t)dt+∫_{Tc2}^{Te}P2(t)dt (Expression 1)

c0=C−(Te−Tc1)×P1−(Te−Tc2)×P2 (Expression 2)

c1=C−(Te−T0)×P0−(Te−Tc2)×P2 (Expression 3)

c2=C−(Te−T0)×P0−(Te−Tc1)×P1 (Expression 4)

C represents a capacity of a task as a processing target. C0 represents an allocated capacity of a task of the vehicle 100, C1 represents an allocated capacity of a task of the vehicle 102, and C2 represents an allocated capacity of a task of the vehicle 104. A unit of C, C0, C1, and C2 is, for example, byte. T0 represents a current time, Te represents a predicted processing end time of all vehicles, Tc1 represents a predicted communication start time of the vehicle 102, and Tc2 represents a predicted communication start time of the vehicle 104. P0 represents predicted processing performance during communication of the vehicle 100, P1 represents predicted processing performance during communication of the vehicle 102, and P2 represents predicted processing performance during communication of the vehicle 104. A unit of P0, P1, and P2 is, for example, byte/sec. Conditions are set such that each vehicle is capable of communicating continuously until the time Te, Tc2≥Tc1≥Tc0 is satisfied, C0, C1, and C2 of the respective vehicles fall below P0, P1, and P2, and all parameters show positive values.

As described above, the communication control unit 210 may decide the allocated capacity of a task so as to request other vehicles of the task that cannot be fully processed by the own vehicle, based on the expected processing end time of all vehicles. The communication control unit 210 may decide the allocated capacity of a task of each vehicle so that redundancy is generated in processing performance so as to enable a request of a task from further another vehicle 100 to be accepted while the vehicle 100, the vehicle 102, and the vehicle 104 are performing the distribution processing.

In the above-described embodiment, the information processing device mounted on the movable object has been mainly described, but the present invention is not limited thereto. The information processing device may be installed fixedly. For example, the fixed AP 400 may function as the information processing device.

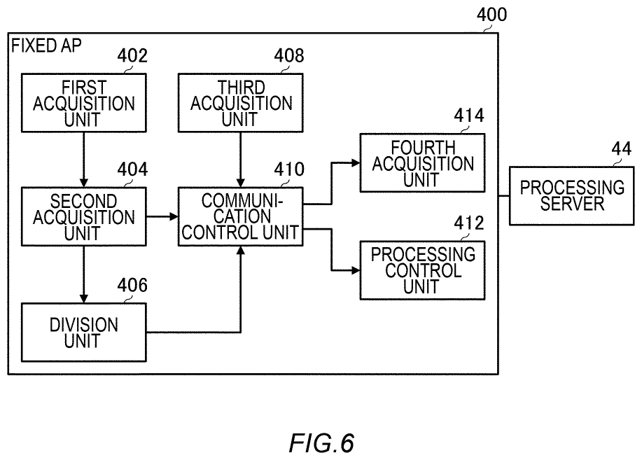

FIG. 6 schematically shows an example of a functional configuration of the fixed AP 400 that functions as the information processing device. The fixed AP 400 includes a first acquisition unit 402, a second acquisition unit 404, a division unit 406, a third acquisition unit 408, a communication control unit 410, a processing control unit 412, and a fourth acquisition unit 414. Differences from the information processing device 200 will mainly be described herein.

The first acquisition unit 402 acquires a task as a processing target. The first acquisition unit 402 generates a task as a processing target, for example. The first acquisition unit 402 may receive a task from any device on the network 20.

The second acquisition unit 404 acquires a processing time of the task acquired by the first acquisition unit 402. The second acquisition unit 204 may derive an expected processing time in a case where the processing server 44 processes a task as a prediction result of the processing time of the task. The processing server 44 may be an example of the task processing unit. Herein, a case where the processing server 44 is used will mainly be taken as an example, but a processing unit provided in the fixed AP 400 may be used instead.

The second acquisition unit 404 may derive an expected processing time in a case where an external communication device in the vicinity of the fixed AP 400 processes a task, as a prediction result of the processing time of the task. For example, the second acquisition unit 404 may derive an expected processing time in a case where the vehicle 100 traveling on a road in front of the fixed AP 400 processes a task, as a prediction result of the processing time of the task. For example, the second acquisition unit 404 can acquire in advance from the vehicle 100 the processing performance and available resource of the vehicle 100, and derive, based on the processing performance and available resource of the vehicle 100, an expected processing time in a case where the vehicle 100 processes a task.

The division unit 406 may divide the task acquired by the first acquisition unit 402 into an own processing task to be processed by the processing server 44 and a request task that is requested to be processed by the external communication device. The processing time acquired by the second acquisition unit 404 may include an own processing time during which the processing server 44 processes the own processing task and an external processing time during which the external communication device processes the request task. The division unit 406 may divide the task into the own processing task and the request task based on the processing time including the own processing time and the external processing time.

The third acquisition unit 408 acquires a wirelessly communicable period with the external communication device. The third acquisition unit 208 may acquire, as the wirelessly communicable period, a period during which the fixed AP 400 is located within a wireless communication zone of the external communication device.

The third acquisition unit 408 may predict the wirelessly communicable period based on movement-related information which is related to a movement of the movable object on which the external communication device is mounted. For example, when the external communication device is mounted on the vehicle 100, the third acquisition unit 408 predicts the wirelessly communicable period based on location information of the fixed AP 400 and movement-related information of the vehicle 100. The movement-related information of the vehicle 100 may include one or more pieces of information out of location information, traveling direction, traveling speed, destination, road condition, traffic jam information, and traveling history of the vehicle 100.

The communication control unit 410 controls a wireless communication unit provided in the fixed AP 400. Based on the processing time acquired by the second acquisition unit 404 and the wirelessly communicable period acquired by the third acquisition unit 408, the communication control unit 410 may control the wireless communication unit to transmit, to the external communication device, request information that requests to process at least a part of the task as the processing target, that has been acquired by the first acquisition unit 402. The communication control unit 410 may control the wireless communication unit to perform direct communication with the external communication device.

When requesting one external communication device to process a whole task acquired by the first acquisition unit 402, the communication control unit 410 may transmit request information including the task to the one external communication device. When the task is divided into the own processing task and the request task by the division unit 406, the communication control unit 410 may cause the processing server 44 to process the own processing task, and control the wireless communication unit to transmit request information that requests to process the request task to the external communication device.

When the task acquired by the first acquisition unit 402 is divided into the own processing task and a plurality of request tasks by the division unit 406, the communication control unit 410 may cause the processing server 44 to process the own processing task, and control the wireless communication unit to respectively transmit the plurality of request tasks to the plurality of external communication devices. When the first acquisition unit 402 acquires a task included in the request information received from the external communication device and a predetermined condition is satisfied, the communication control unit 410 may cause the wireless communication unit to transmit a rejection response that rejects execution of the task to the external communication device that has transmitted the request information.

The fourth acquisition unit 414 acquires a response to the request information that the wireless communication unit has transmitted to the external communication device. When the fourth acquisition unit 414 does not acquire the response before a predetermined time elapses since the wireless communication unit has transmitted the request information to the external communication device, the communication control unit 410 may cause the wireless communication unit to transmit the request information to another external communication device using direct communication or indirect communication.

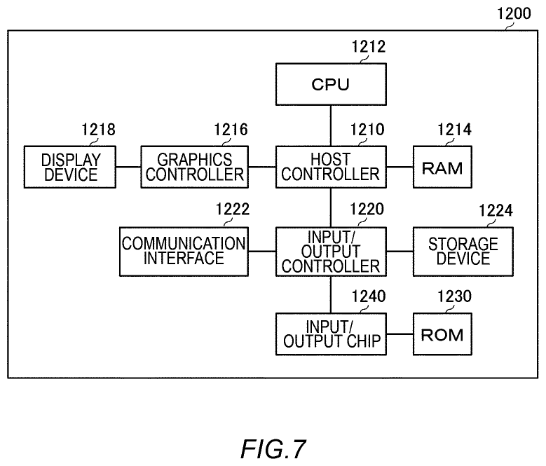

FIG. 7 schematically shows an example of a hardware configuration of a computer 1200 serving as the information processing device 200 or the fixed AP 400. Programs installed in the computer 1200 can cause the computer 1200 to function as one or more “units” of the device according to the present embodiment or can cause the computer 1200 to execute operations associated with the devices according to the present embodiment or the one or more “units”, and/or can cause the computer 1200 to execute a process according to the present embodiment or steps of the process. Such a program may be executed by a CPU 1212 to cause the computer 1200 to execute specific operations associated with some or all of the blocks in the flowchart and block diagrams described in the specification.

The computer 1200 according to the present embodiment includes the CPU 1212, a RAM 1214, and a graphics controller 1216, which are connected to each other via a host controller 1210. The computer 1200 also includes a communication interface 1222, a storage device 1224, and an input/output unit such as an IC card drive, which are connected to the host controller 1210 via an input/output controller 1220. The storage device 1224 may be a hard disk drive, a solid-state drive, and the like. The computer 1200 also includes a ROM 1230 and a legacy input/output unit such as a touch panel, which are connected to the input/output controller 1220 via an input/output chip 1240.

The CPU 1212 operates according to the programs stored in the ROM 1230 and the RAM 1214, thereby controlling each unit. The graphics controller 1216 acquires image data which is generated by the CPU 1212, in a frame buffer or the like provided in the RAM 1214 or in itself so as to cause the image data to be displayed on a display device 1218. A configuration may be adopted where the computer 1200 does not include the display device 1218, and in this case, the graphics controller 1216 causes the image data to be displayed on an external display device.

The communication interface 1222 communicates with other electronic devices via a wireless communication network. The storage device 1224 stores a program and data used by the CPU 1212 in the computer 1200. The IC card drive reads programs and data from an IC card, and/or writes programs and data into the IC card.

The ROM 1230 stores therein a boot program or the like executed by the computer 1200 at the time of activation, and/or a program depending on the hardware of the computer 1200. The input/output chip 1240 may also connect various input/output units to the input/output controller 1220 via a USB port or the like.

The programs are provided via a computer-readable storage medium such as an IC card. The program is read from the computer-readable storage medium, installed into the storage device 1224, RAM 1214, or ROM 1230, which are also examples of the computer-readable storage medium, and executed by the CPU 1212. The information processing described in these programs is read into the computer 1200, resulting in cooperation between a program and the above-described various types of hardware resources. A device or method may be constituted by realizing the operation or processing of information in accordance with the usage of the computer 1200.

For example, when communication is performed between the computer 1200 and an external device, the CPU 1212 may execute a communication program loaded onto the RAM 1214 to instruct communication processing to the communication interface 1222, based on the processing described in the communication program. The communication interface 1222, under the control of the CPU 1212, reads transmission data stored in a transmission buffer processing region provided in a recording medium such as the RAM 1214, the storage device 1224, or the IC card, transmits the read transmission data to the network, or writes reception data received from the network into a reception buffer processing region or the like provided on the recording medium.

In addition, the CPU 1212 may cause all or necessary portion of a file or a database stored in the external recording medium such as the storage device 1224 or the IC card, to be read by the RAM 1214, and execute various types of processing on the data on the RAM 1214. The CPU 1212 may then write back the processed data to the external recording medium.

Various types of information, such as various types of programs, data, tables, and databases, may be stored in the recording medium to undergo information processing. The CPU 1212 may perform various types of processing on the data read from the RAM 1214, which includes various types of operations, information processing, condition judging, conditional branch, unconditional branch, search/replacement of information, and the like, as described throughout this disclosure and designated by an instruction sequence of programs, and writes the result back to the RAM 1214. In addition, the CPU 1212 may search for information in a file, a database, and the like, in the recording medium. For example, when a plurality of entries, each having an attribute value of a first attribute associated with an attribute value of a second attribute, are stored in the recording medium, the CPU 1212 may search for an entry whose attribute value of the first attribute matches a designated condition, from among the plurality of entries, and read the attribute value of the second attribute stored in the entry, thereby obtaining the attribute value of the second attribute associated with the first attribute satisfying the predetermined condition.

The programs or software module described above may be stored on the computer 1200 or in a computer-readable storage medium near the computer 1200. In addition, a recording medium such as a hard disk or a RAM provided in a server system connected to a dedicated communication network or the Internet can be used as the computer-readable storage medium, thereby providing the program to the computer 1200 via the network.

The flowchart and the blocks in the block diagrams according to the present embodiment may represent a step of a process in which an operation is executed or a “unit” of a device which has a role of executing an operation. Certain steps and “units” may be implemented by dedicated circuitry, programmable circuitry supplied with computer-readable instructions stored on a computer-readable storage medium, and/or processors supplied with computer-readable instructions stored on a computer-readable storage medium. Dedicated circuitry may include digital and/or analog hardware circuits, and may include integrated circuits (IC) and/or discrete circuits. For example, programmable circuitry may include reconfigurable hardware circuits including logical AND, OR, XOR, NAND, NOR, and other logical operations, flip-flops, registers, and memory elements, such as field-programmable gate arrays (FPGA), programmable logic arrays (PLA), and the like.

A computer-readable storage medium may include any tangible device that can store instructions for execution by a suitable device, such that the computer-readable storage medium having instructions stored therein includes an article of manufacture including instructions which can be executed to create means for executing operations specified in the flowchart or block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY (registered trademark) disc, a memory stick, an integrated circuit card, and the like.

The computer-readable instruction may include an assembler instruction, an instruction-set-architecture (ISA) instruction, a machine instruction, a machine dependent instruction, a microcode, a firmware instruction, state-setting data, or either a source code or object code written in any combination of one or more programming languages including an object oriented programming language such as Smalltalk(registered trademark), JAVA (registered trademark), C++, or the like and a conventional procedural programming language such as a “C” programming language or a similar programming language.

Computer-readable instructions may be provided to a processor of a general-purpose computer, a special-purpose computer, or other programmable data processing apparatuses, or to programmable circuitry, locally or via a local area network (LAN) or a wide area network (WAN) such as the Internet, so that the processor of the general-purpose computer, special-purpose computer, or other programmable data processing apparatuses, or the programmable circuitry executes the computer-readable instructions to create means for executing operations specified in the flowchart or block diagrams. Examples of the processor include a computer processor, a processing unit, a microprocessor, a digital signal processor, a controller, a microcontroller, and the like.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: system, 20: network, 30: wireless base station, 42: processing server, 44: processing server, 100, 102, 104: vehicle, 110: processing unit, 120: wireless communication unit, 130: image capturing unit, 140: microphone, 200: information processing device, 202: first acquisition unit, 204: second acquisition unit, 206: division unit, 208: third acquisition unit, 210: communication control unit, 212: processing control unit, 214: fourth acquisition unit, 400: fixed AP, 402: first acquisition unit, 404: second acquisition unit, 406: division unit, 408: third acquisition unit, 410: communication control unit, 412: processing control unit, 414: fourth acquisition unit, 1200: computer, 1210: host controller, 1212: CPU, 1214: RAM, 1216: graphics controller, 1218: display device, 1220: input/output controller, 1222: communication interface, 1224: storage device, 1230: ROM, 1240: input/output chip

What is claimed is:

1. An information processing device comprising:
a first acquisition unit configured to acquire a task;
a second acquisition unit configured to acquire a processing time of the task;
a third acquisition unit configured to acquire a wirelessly communicable period with an external communication device; and
a communication control unit configured to control, based on the processing time and the wirelessly communicable period, a wireless communication unit to transmit request information to the external communication device, the request information requesting to process at least a part of the task,
wherein the communication control unit is configured to control the wireless communication unit to perform direct communication with the external communication device.

2. The information processing device according to claim 1, wherein
the communication control unit is configured to control, when the external communication device is requested to process the at least a part of the task and it is determined, based on the processing time and the wirelessly communicable period, that a processing result can be received from the external communication device, the wireless communication unit to transmit the request information to the external communication device.

3. The information processing device according to claim 1, comprising:
a processing control unit configured to control a task processing unit; and
a division unit configured to divide the task into an own processing task to be processed by the task processing unit and a request task requested to be processed by the external communication device,
wherein
the processing time includes an own processing time during which the task processing unit processes the own processing task, and an external processing time during which the external communication device processes the request task,
the division unit is configured to divide the task into the own processing task and the request task based on the processing time,
the processing control unit is configured to cause the task processing unit to process the own processing task, and
the communication control unit is configured to control the wireless communication unit to transmit the request information requesting to process the request task to the external communication device.

4. The information processing device according to claim 2, comprising:
a processing control unit configured to control a task processing unit; and
a division unit configured to divide the task into an own processing task to be processed by the task processing unit and a request task requested to be processed by the external communication device,
wherein
the processing time includes an own processing time during which the task processing unit processes the own processing task, and an external processing time during which the external communication device processes the request task,
the division unit is configured to divide the task into the own processing task and the request task based on the processing time,
the processing control unit is configured to cause the task processing unit to process the own processing task, and
the communication control unit is configured to control the wireless communication unit to transmit the request information requesting to process the request task to the external communication device.

5. The information processing device according to claim 3, wherein
the division unit is configured to divide the task into the own processing task and a plurality of the request tasks respectively corresponding to a plurality of the external communication devices, and
the communication control unit is configured to control the wireless communication unit to respectively transmit the plurality of request tasks to the plurality of external communication devices.

6. The information processing device according to claim 1, comprising
a division unit configured to divide the task into a plurality of request tasks requested to be respectively processed by a plurality of the external communication devices,
wherein the communication control unit is configured to control the wireless communication unit to respectively transmit the plurality of request tasks to the plurality of external communication devices.

7. The information processing device according to claim 1, wherein
the first acquisition unit is configured to acquire the task included in the request information received from the external communication device.

8. The information processing device according to claim 7, wherein
the communication control unit is configured to, when the first acquisition unit acquires the task included in the request information received from the external communication device and a predetermined condition is satisfied, cause the wireless communication unit to transmit a rejection response for rejecting execution of the task to the external communication device which has transmitted the request information.

9. The information processing device according to claim 1, comprising
a fourth acquisition unit configured to acquire a response to the request information transmitted from the wireless communication unit to the external communication device,
wherein the communication control unit is configured to, when the fourth acquisition unit does not acquire the response before a predetermined time elapses after the wireless communication unit has transmitted the request information, cause the wireless communication unit to transmit the request information to another external communication device using direct communication or indirect communication.

10. The information processing device according to claim 1, wherein
the direct communication is narrowband wireless communication.

11. The information processing device according to claim 1, wherein
the wireless communication unit is configured to transmit the request information to the external communication device using a communication system having a lower communication cost than a cellular communication system.

12. The information processing device according to claim 1, wherein
the information processing device is mounted on a movable object, and
the third acquisition unit is configured to acquire, as the wirelessly communicable period, a period during which the information processing device is located within a wireless communication zone of the external communication device.

13. The information processing device according to claim 12, wherein
the third acquisition unit is configured to predict the wirelessly communicable period based on first movement-related information related to a movement of the movable object on which the information processing device is mounted.

14. The information processing device according to claim 13, wherein
the external communication device is mounted on a movable object, and
the third acquisition unit is configured to predict the wirelessly communicable period based on the first movement-related information and second movement-related information related to a movement of the movable object on which the external communication device is mounted.

15. The information processing device according to claim 12, wherein
the information processing device is mounted on a vehicle, and
the first acquisition unit is configured to acquire a task generated by the vehicle.

16. The information processing device according to claim 15, wherein
the first acquisition unit is configured to acquire a task of analyzing a captured image captured by an image capturing unit mounted on the vehicle.

17. The information processing device according to claim 15, wherein
the first acquisition unit is configured to acquire a task of analyzing a voice acquired by a microphone mounted on the vehicle.

18. A non-transitory computer-readable storage medium having stored thereon a program for causing a computer to function as:
an information processing device including:
a first acquisition unit configured to acquire a task;
a second acquisition unit configured to acquire a processing time of the task;
a third acquisition unit configured to acquire a wirelessly communicable period with an external communication device; and
a communication control unit configured to control, based on the processing time and the wirelessly communicable period, a wireless communication unit to transmit request information to the external communication device, the request information requesting to process at least a part of the task,
wherein the communication control unit is configured to control the wireless communication unit to perform direct communication with the external communication device.

19. A system comprising:
the information processing device according to claim 12; and
the movable object on which the information processing device is mounted.

20. An information processing method executed by an information processing device, comprising:
first acquiring a wirelessly communicable period with an external communication device;
second acquiring a processing time of a task; and
controlling communication by controlling, based on the wirelessly communicable period and the processing time, a wireless communication unit to transmit request information to the external communication device, the request information requesting to process a request task which is at least a part of the task,
wherein the controlling communication includes controlling the wireless communication unit to perform wireless communication with the external communication device.
